(19) United States
(12) Patent Application Publication
(10) Pub. No.: US 2009/0265854 A1
(43) Pub. Date: Oct. 29, 2009

(54) SANITARY CARE BED FOR BEDFAST PATIENTS

(76) Inventor: Kenneth Lindsay Pagden, New South Wales (AU)

Correspondence Address: YOUNG BASILE, 3001 WEST BIG BEAVER ROAD, SUITE 624, TROY, MI, 48084, US

(21) Appl. No.: 12/092,187

(22) PCT Filed: Oct. 27, 2006
(86) PCT No.: PCT/AU2006/001612

§ 371 Date: Aug. 8, 2008

(30) Foreign Application Priority Data
Nov. 2, 2005 (AU) 2005906035

(51) Int. Cl. A61G 7/05; A61G 7/02; A61G 7/10

(52) U.S. Cl. 5/606; 5/88.1

(57) ABSTRACT

This invention provides a bed for a patient including a patient lifting means; and a length of moveable sheet material, wherein a first portion of the sheet material is aligned below the patient support, and the sheet material is moveable such that the portion is no longer aligned below the patient and is replaced with a second portion of the sheet material.

### FIELD OF THE INVENTION

The present invention relates to hospital beds, and more specifically to beds for a bedfast patient where sanitary care can be performed with the patient remaining in-situ.

### BACKGROUND OF THE INVENTION

Any discussion of the prior art throughout the specification should in no way be considered as an admission that such prior art is widely known or forms part of common general knowledge in the field.

Oblutionary care of incontinent elderly and bedfast patients in hospital and nursing homes remains a very labour intensive and expensive procedure in terms of laundering and manual labour, with the ever present risk of back injuries for the attendant staff. From the patients point of view, lack of attention to soiled bed linen quickly results in skin damage and the attendant decubitis ulcer risk.

It is therefore an object of the present invention to overcome or ameliorate at least one of the disadvantages of the prior art, or to provide a useful alternative.

### SUMMARY OF THE INVENTION

To this end, the present invention provides a bed for a patient comprising:
a patient lifting means; and
a length of moveable sheet material,
wherein a first portion of the sheet material is aligned below the patient lifting means, and the sheet material is moveable such that the first portion is no longer aligned below the patient and is replaced with a second portion of the sheet material.

Preferably, the sheet material is impervious. More preferably, the sheet material includes a layer of absorbent material. More preferably, the layer of absorbent material is removable. More preferably, the absorbent material includes a paper lining.

Preferably, the sheet material is a continuous loop. More preferably, the loop is retained on a plurality of rollers. Preferably, the loop is removable from the rollers. Preferably, the bed includes at least two loops of the sheet material.

Preferably, the loops are movable in opposing directions.

Preferably, the bed extends longitudinally and the sheet material is moveable in a longitudinal direction.

Preferably the bed further includes a sanitation system for cleaning the first portion. More preferably, the sanitation system includes a spraying means for spraying a fluid onto the first portion to remove waste material. More preferably, the spraying means includes at least one nozzle.

Preferably, the fluid is sanitised water. More preferably, the sanitised water is maintained at a constant temperature.

Preferably, the sanitation system includes a waste outlet for removing the waste material from the system. More preferably, the waste outlet is in fluid communication with a plumbing system.

Preferably, the waste outlet is in fluid communication with a portable collection vessel.

Preferably, the sanitation system includes a fan for introducing air into the system for drying the first portion.

Preferably, the sanitation system includes an exhaust outlet.

Preferably, the bed further includes a sensor to detect when the first portion is soiled. More preferably, the sensor is located adjacent the first portion. More preferably, the sensor is a moisture sensor.

Preferably, the patient lifting means includes tensionable straps for lifting the patient away from the first portion. In one embodiment the tensionable straps can be tensioned manually, whilst in an alternative embodiment the tensionable straps can be tensioned automatically.

Advantageously, in at least a preferred embodiment, the present invention provides a linenless bedform apparatus which enables sanitary care of a bedfast patient to be carried out safely and efficiently and which reduces laundering and difficult lifting of the patient.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### BRIEF DESCRIPTION OF DRAWINGS

A preferred embodiment of the invention will now be described, by way of example only, with reference to the accompanying drawings in which:

FIG. 1 is a perspective view of a bed frame assembly according to a preferred embodiment of the invention;

FIG. 2 is an end elevation of the bed assembly illustrated in FIG. 1;

FIG. 3 is a plan view of the bed assembly of FIG. 1;

FIG. 4 is a side elevation of the bed assembly of FIG. 1;

FIG. 5 is a perspective view of a bed according to a preferred embodiment of the invention;

FIG. 6 is an end elevation of the bed illustrated in FIG. 5;

FIG. 7 is a plan view of the bed of FIG. 5; and

FIG. 8 is a side elevation of the bed of FIG. 5;

### DESCRIPTION OF PREFERRED EMBODIMENT

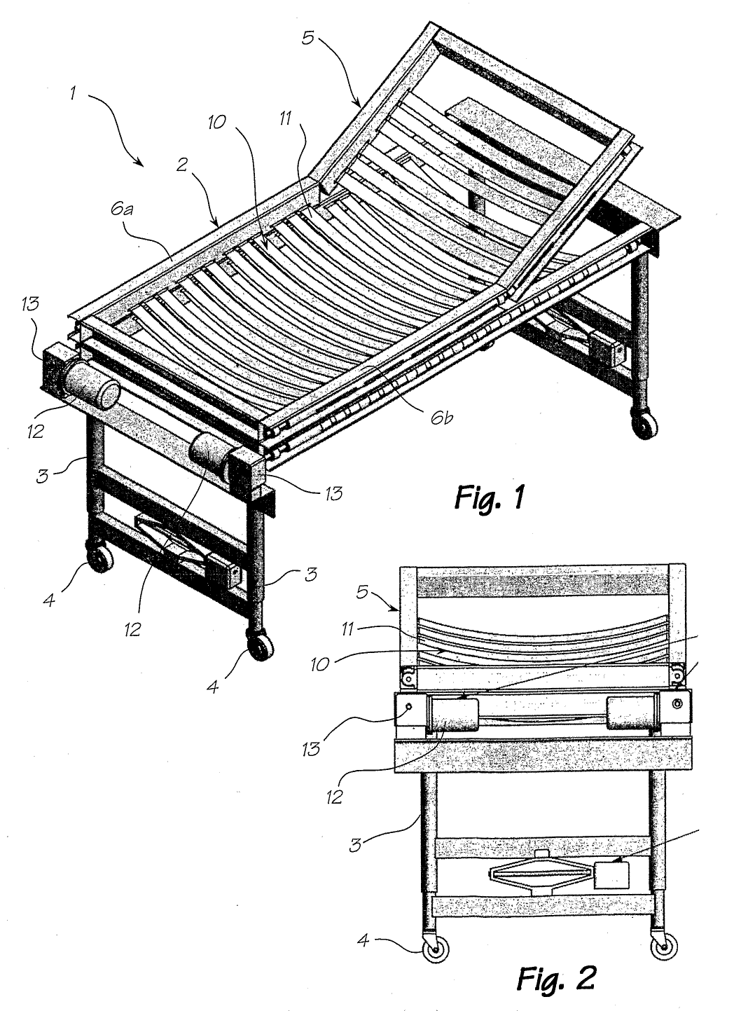

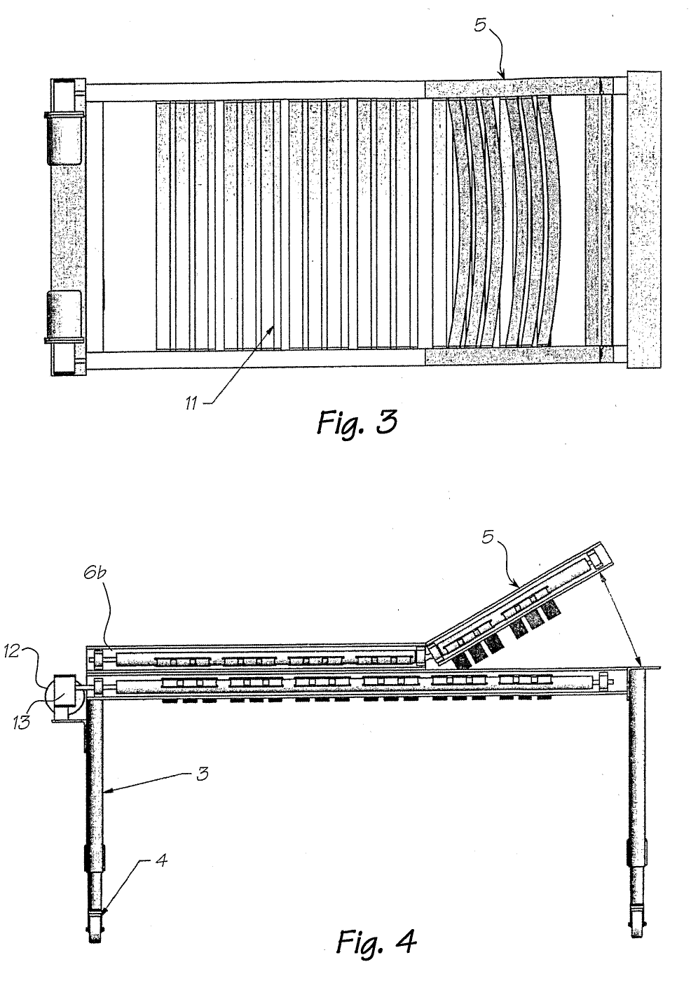

FIGS. 1 to 4 illustrate the bed frame assembly 1 according to a preferred embodiment of the invention. The assembly includes a rectilinear frame 2 mounted on height adjustable legs 3 with lockable castors 4 to aid in manoeuvrability of the bed. The frame 2 is segmented such that a section 5 of the frame at one end of the bed (typically the “head” end of the bed) can be tilted to adjust the positioning of the patient as shown in FIGS. 1 and 4. The frame is provided with a plurality of laterally extending flexible members 10. In the preferred embodiment the flexible members 10 take the form of straps 11 which extend between longitudinal frame members 6a, 6b. The tension in the straps is adjustable and by adjusting the tensioning of the straps the patient can be lifted and lowered vertically. Tensioning of the straps results in the patient being raised, whilst de-tensioning the straps results in the patient being lowered. In a preferred embodiment tensioning of the straps is performed by means of one or more reversible electric motors 12 and associated roller drives 13.

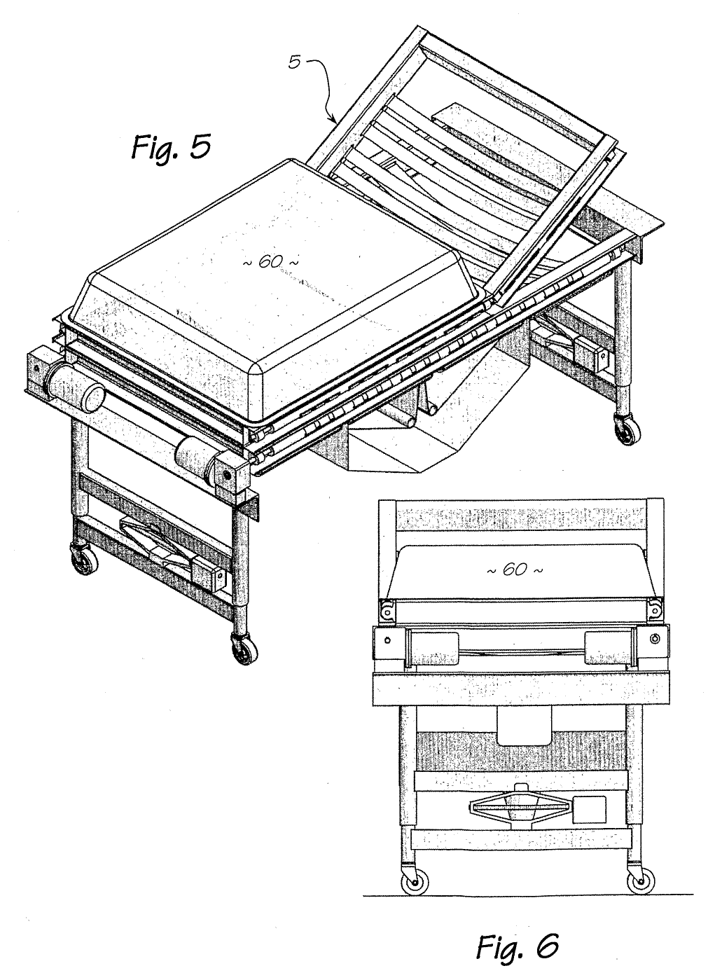

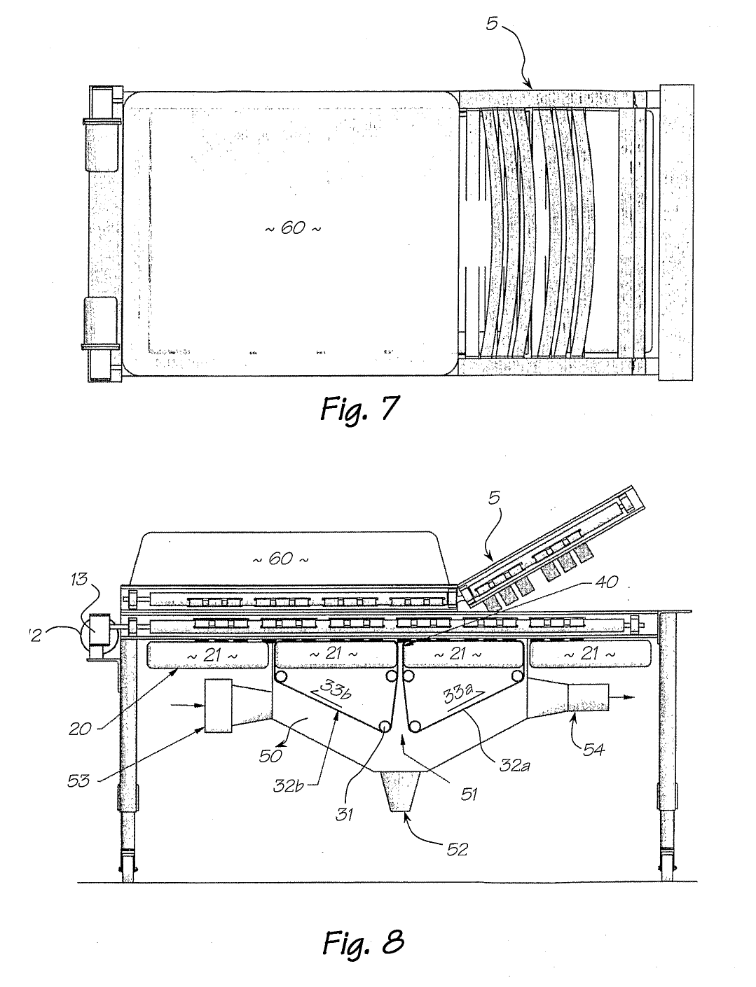

Referring to FIGS. 5 to 8, located beneath the lifting straps 11 is cushioning 20 for supporting the patient when lying in the bed. In a preferred embodiment cushioning 20 takes the form of a plurality of water filled cushions 21 which act to support the patient when the lifting straps 11 are de-tensioned. To lift the patient above the cushioning, the lifting straps 11 are tensioned sufficiently to support the weight of the patient and lift the patient clear of the cushioning.

Located between the lifting straps 11 and the cushioning 20 and aligned beneath the patient is a length of moveable sheet material 30. The sheet material is impervious and includes a removable covering layer of absorptive paper lining. Preferably the sheet material is provided in a continuous loop and retained on a plurality of rollers 31 for movement in the longitudinal direction. Preferably there are a pair of loops 32a, 32b of the sheet material which are movable in opposing directions as indicated by the arrows 33a, 33b in FIG. 8.

Located between the opposed loops 32a, 32b is automatic moisture sensing equipment 40. The moisture sensing equipment includes a moisture sensor located adjacent the sheet material to detect when the sheet material beneath the patient has been soiled.

Suspended beneath the movable sheeting is a sanitation system 50 including washing and drying equipment to remove the paper surfacing from the soiled sheet and sanitise the surface of the impervious sheeting in preparation for re-use. The sanitation system includes a spraying means 51 for spraying a cleaning fluid onto the sheet material. In the preferred embodiment the spraying means includes one or more nozzles and the cleaning fluid is sanitised water which is maintained at a constant temperature. The sanitation system 50 further includes a waste outlet 52 for removing the waste material. The waste outlet 52 may be in fluid communication with a plumbing system, or alternatively in fluid communication with a portable collection vessel. The system further includes a fan 53 for introducing air for drying of the sheet material and an exhaust outlet 54.

The sanitising procedure may be electronically or manually initiated causing the lifting straps to tension and lift the body of the patient clear of the continuous sheeting section. This enables wash down procedures with a hand held spray to be performed and also allows for the soiled sheeting to revolve down into the treatment chamber to be sanitised in preparation for later re-use.

After having been washed and air dried the lifting straps are de-tensioned, thereby lowering the patient back onto the sanitised sheeting, freshly lined with absorptive paper sheeting. Controlled air flow in the apparatus ensures all offensive odours are exhausted to the outside atmosphere.

Preferably the bed further includes hairdressing facilities, to enable the head and hair of the patient to be washed and dried whilst the patient remains in-situ.

Although the invention has been described with reference to specific examples it will be appreciated by those skilled in the art that the invention may be embodied in many other forms.

1. A bed for a patient including:
a patient lifting means; and
a length of moveable sheet material,
wherein a first portion of said sheet material is aligned below said patient lifting means, and said sheet material is moveable such that said portion is no longer aligned below said patient and is replaced with a second portion of said sheet material.

2. A bed for a patient according to claim 1 wherein said sheet material is impervious.

3. A bed for a patient according to claim 2 wherein said sheet material includes a layer of absorbent material.

4. A bed for a patient according to claim 3 wherein said layer of absorbent material is removable.

5. A bed for a patient according to claim 4 wherein said absorbent material includes a paper lining.

6. A bed for a patient according to claim 1 wherein said sheet material is a continuous loop.

7. A bed for a patient according to claim 6 wherein said loop is retained on a plurality of rollers.

8. A bed for a patient according to claim 6 wherein said loop is removable from said rollers.

9. A bed for a patient according to claim 6 further including at least two said loops of said sheet material.

10. A bed for a patient according to claim 9 wherein said loops are movable in opposing directions.

11. A bed for a patient according to claim 1 wherein said bed extends longitudinally and said sheet material is moveable in a longitudinal direction.

12. A bed for a patient according to claim 1 further including a sanitation system for cleaning said first portion.

13. A bed for a patient according to claim 12 wherein said sanitation system includes a spraying means for spraying a fluid onto said first portion to remove waste material.

14. A bed for a patient according to claim 13 wherein said spraying means includes at lease one nozzle.

15. A bed for a patient according claim 13 wherein said fluid is sanitised water.

16. A bed for a patient according to claim 15 wherein said sanitised water is maintained at a constant temperature.

17. A bed for a patient according to claim 12 wherein said sanitation system includes a waste outlet for removing said waste material from said system.

18. A bed for a patient according to claim 17 wherein said waste outlet is in fluid communication with a plumbing system.

19. A bed for a patient according to claim 17 wherein said waste outlet is in fluid communication with a portable collection vessel.

20. A bed for a patient according to claim 12 wherein said sanitation system includes a fan for introduction air into said system for drying said first portion.

21. A bed for a patient according to claim 12 wherein said sanitation system includes an exhaust outlet.

22. A bed for a patient according to claim 1 further including a sensor to detect when said first portion is soiled.

23. A bed for a patient according to claim 22 wherein said sensor is located adjacent said first portion.

24. A bed for a patient according to claim 22 wherein said sensor is a moisture sensor.

25. A bed for a patient according to claim 1 wherein said patient lifting means includes tensionable straps for lifting said patient away from said first portion.

26. A bed for a patient according to claim 25 wherein said tensionable straps are tensioned automatically.
